(19) United States
(12) Patent Application Publication
(10) Pub. No.: US 2006/0192318 A1
(43) Pub. Date: Aug. 31, 2006

(54) Method of producing a motor vehicle fitting part

(75) Inventors: Olaf Benkler, Neuhausen/Schellbronn (DE); Reinhard Duepjohann, Renningen-Malmsheim (DE)

Correspondence Address: CROWELL & MORING LLP;INTELLECTUAL PROPERTY GROUP, P.O. BOX 14300, WASHINGTON, DC, 20044-4300, US

(73) Assignee: Dr. Ing. h.c.F. Porsche Aktiengesellschaft, Stuttgart (DE)

(21) Appl. No.: 11/354,822

(22) Filed: Feb. 16, 2006

(30) Foreign Application Priority Data
Feb. 19, 2005 (DE) 10 2005 007 645.9

(51) Int. Cl. B29C 45/14

(52) U.S. Cl. 264/259; 264/296

(57) ABSTRACT

A method of producing a motor vehicle fitting part which injects a plastic material essentially over the full surface behind a metal foil, with the fitting part having a finished or final form. In order to be able to produce the motor vehicle fitting part with an accurate fit, the metal foil is changed to a bent preform extending at least in a first direction, before an injection behind the metal foil takes place, and the plastic material is applied to the thus deformed metal foil, the preform deviating from the finished or final form.

This application claims the priority of DE 10 2005 007 645.9 filed Feb. 19, 2005, the disclosure of which is expressly incorporated by reference herein.

### BACKGROUND AND SUMMARY OF THE INVENTION

The present invention relates to a method of producing a motor vehicle fitting part in which a plastic material is injected substantially over the full surface behind a metal foil and the fitting part is in finished or final form.

A method for producing a motor vehicle fitting part is known from DE 102 11 171 A1. According to this known production process, a metal foil is placed in a cavity of a tool and the space in the cavity which remains free is filled with a plastic material, so that this plastic material is essentially injected behind the entire metal foil. The finished fitting part is inserted in its finished or final form into the motor vehicle, for example, as a fitting part. The metal foil consists of high-grade steel and, for example, has a material thickness which is greater than 0.3 mm.

DE 103 43 259 A1 discloses that it was also known to produce an automobile component from a metal foil behind which a plastic material is injected and to subject it to a treatment by a plasma jet. As a result, the temperatures of the plastic material required during the injection behind the metal foil are reduced.

In addition, a production process is described in DE 34 31 666 A1 in which wood plates can be produced with a bordering of plastic material by a spray-on process. The plastic bordering has an asymmetrical cross-section. Before the spraying of the plastic material onto the border area, the wood plate is changed into a prestressed curved shape in order to be able to compensate the shrinkage forces originating from the asymmetrical cross-section of the bordering.

An object of the present invention is to provide a method for producing a motor vehicle fitting part of high quality.

This object has been achieved by a method in which foil takes place, the metal foil is changed to a bent perform extending at least in a first direction and the plastic material is applied to the thus deformed metal foil, the perform deviating from the finished or final form.

Among the principal advantages achieved by the present invention are that motor vehicle fitting parts can be produced which have a precise finished or final form. During the manufacturing of such composite components, which consist of a metal foil behind the entire surface of which a plastic material is injected, as a result of different coefficients of thermal expansion of the used materials, the shape of the fitting part may change during the cooling. In particular, the shape may be curved or bent into an undesirable direction, which occurs in a similar manner in the case of the so-called bimetal effect. Although the imposition of a bending or a curvature according to the invention upon the metal foil behind which the injection is to take place does not prevent this bimetal effect, the cooled fitting part will later have the desired finished or final form when, as a result of this bimetal effect, during the cooling, the fitting part deforms into the desired finished or final form.

With the production process according to the invention, particularly motor vehicle fitting parts can be produced which extend along a significant length or width of the motor vehicle. For example, side member coverings, decorative parts extending over the width of a dashboard, protective parts for a trunk bottom or the like, can be manufactured in this manner. Particularly in the case of fitting parts of this type, this bimetal effect may occur in an intensified manner as a result of the length of the fitting part, particularly at the ends of the fitting part. As a result of the prestressing in the metal foil according to the invention into the bent preform, however, a fitting part can be produced having a metal foil, behind which the injection took place, which fitting part can inserted into the motor vehicle in a precise manner with respect to measurements and fit.

It has been found that the finished or final form of a the fitting part can further be advantageously influenced if the respective bending angle of the bent preform can be selected to be increasingly larger in the direction of an edge of the metal foil.

In a further development according to the present invention, for the preform, the metal foil can be deformed, in addition to the first bending direction, in a second bending direction. The bending directions for the preform can therefore extend in the direction of the length and/or width of the fitting part and/or transversely. Thus, the metal foil can be preformed in the shape of a spherical cap.

Other objects, advantages and novel features of the present invention will become apparent from the following detailed description of the invention when considered in conjunction with the accompanying drawings.

### BRIEF DESCRIPTION OF THE DRAWINGS

FIG. 1 is a perspective view of a motor vehicle fitting part in its finished or final form;

FIG. 2 is a sectional view of the fitting part shown in FIG. 1 having been inserted into a motor vehicle;

FIGS. 3 to 5 are sectional views respectively of the fitting part shown in FIG. 1, the finished or final form as well as the preform of the fitting part being illustrated; and

FIG. 6 is a schematic sectional view of a tool having a cavity for producing the fitting part.

### DETAILED DESCRIPTION OF THE DRAWINGS

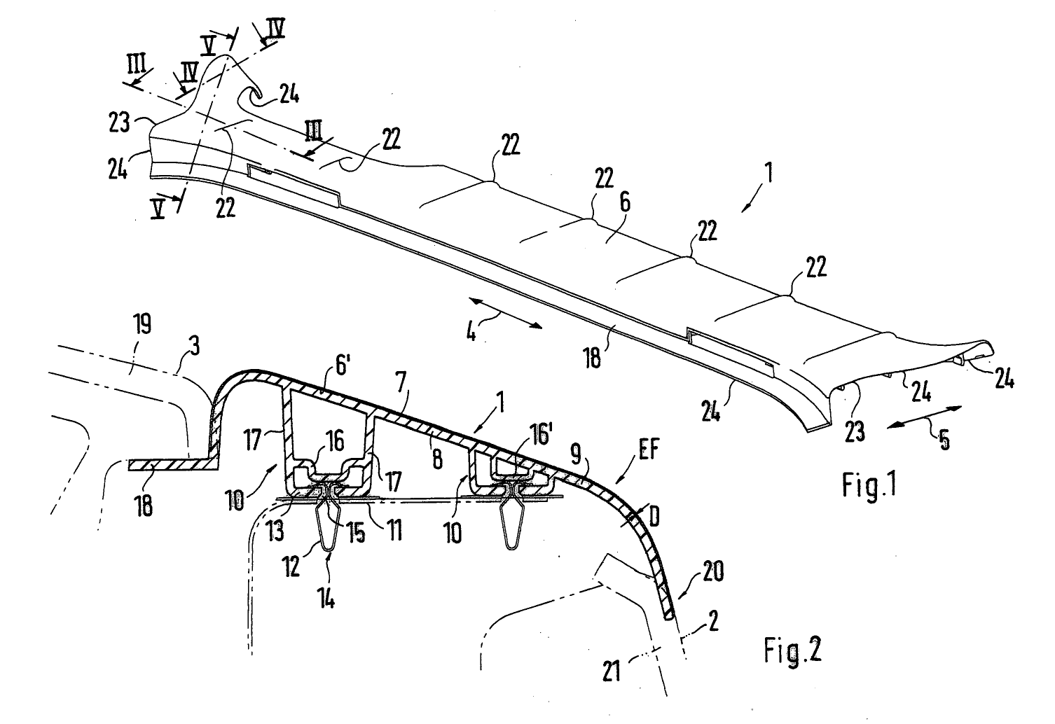

Referring now to FIGS. 1 and 2, a motor vehicle fitting part will be explained in detail which will only be called a fitting part 1 hereinafter. In particular, this is an inside fitting part for a vehicle interior (not shown in detail) or a fitting part 1 for a trunk floor 2 as shown in FIG. 2. In the illustrated embodiment, the trunk floor 2 has a stepped construction and, by way of the fitting part 1, changes into a so-called rear window shelf 3. The rear window shelf 3 and the trunk 2 are therefore a component of a single vehicle interior.

According to FIG. 1, the fitting part 1 has a length measured in the direction of the arrow 4 and a width measured in the direction of the arrow 5. It is shown that the length is significantly greater than the width. FIG. 2 is therefore a sectional view in the direction of the width 5 of the fitting part 1. The length 4 of the fitting part 1 can be selected such that it extends along almost the entire width of the interior of the motor vehicle or over a significant portion of this width. When the fitting part 1 is used, for example, as a side member covering, it therefore extends over a significant length of the motor vehicle 1, particularly along the length of the door opening in the side member area.

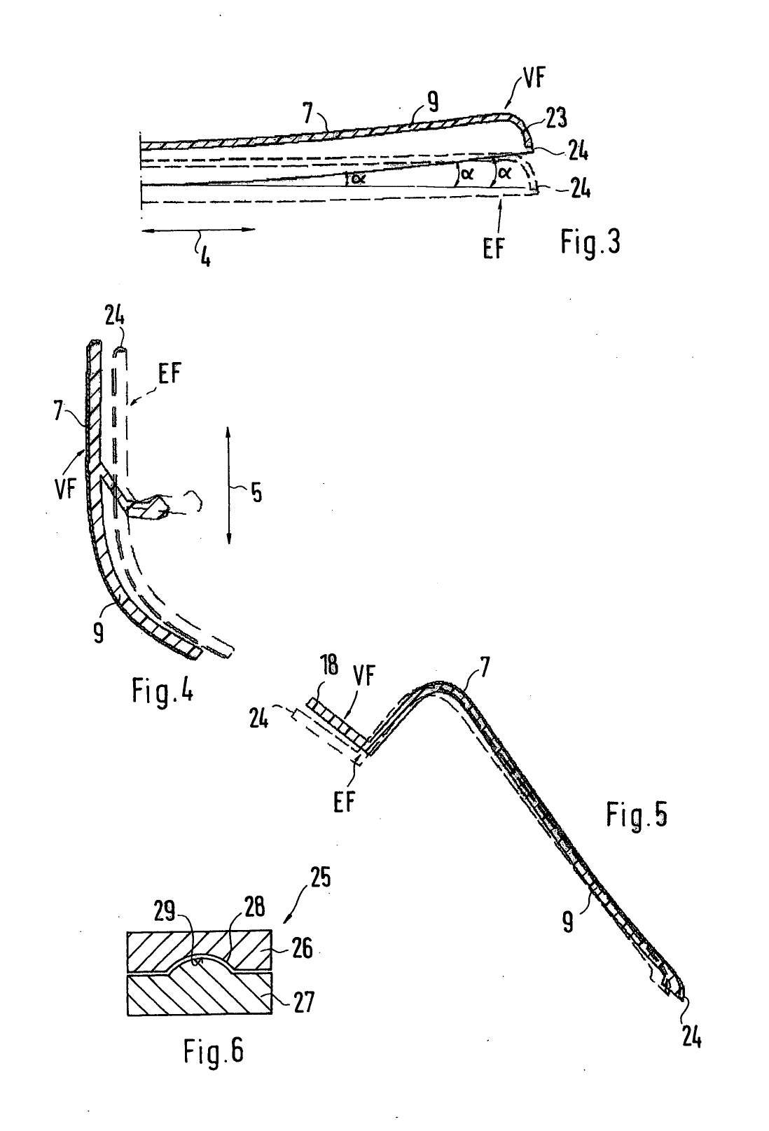

The fitting part 1 is constructed as a composite part and, on its top side 6, has a metal foil 7, particularly a high-grade steel foil, forming the surface which is arranged on a plastic carrier 8. The plastic carrier 8 is connected with the metal foil 7 by injecting behind a rear side 6′ of the metal foil 7, which will be discussed below in connection with FIGS. 3 to 5. The plastic carrier 8 comprises a flat carrier bed 9 to which the metal foil 7 is fastened with its back side 6′. The carrier bed 9 can be constructed with a constant cross-section in the direction of the length 4 and/or the width 5.

At least one supporting element 10 with a U-shaped cross-section extends out preferably in one piece from the carrier bed 9 and supports the carrier bed 9 at a distance from a vehicle body element 11 situated below it. In order to be able to fasten the fitting part 1 to the vehicle body element 11, a corresponding fastening element 12 is provided which may be constructed, for example, as a spring clip. The fastening element 12 reaches behind a base 13 of the supporting element 10 and projects by way of a fastening section 14 through an opening 15 in the base 13 out of the supporting element 10. Inside the supporting element 10, an abutment in the form of a profiled transverse web 16 is arranged for the fastening element 12.

As illustrated in FIG. 2, several supporting elements 10 may be provided which may have a different height for an oblique arrangement of the fitting part 1, and otherwise have an identical construction with the exception of the profiled transverse web 16. In the case of the supporting element shown on the right in FIG. 2, the profiled transverse web 16′ extends out from the carrier bed 9 and essentially has a U-shape, whereas the transverse web 16 extends between the two upright sections 17 of the U-shaped supporting element 10. On the edge side, an underreaching section 18 extends out from the carrier bed 9 and reaches under a covering part 19 of the rear window shelf 3. The underreaching section 18 can be constructed without a metal foil 7.

On its end situated opposite the underreaching section 18, the fitting part 1 also has an overlapping section 20 which rests on a covering part 21 covering the trunk floor 2. As further illustrated in FIG. 1, the top side 6 has one or more elevations 22 which are spaced with respect to one another and extend in the direction of the width 5. These elevations are formed by beads in the metal foil 7 and are filled with the plastic material of the carrier bed 9 which supports the metal foil 7 essentially over the entire surface, thus essentially over the entire back side 6′. The plastic material for the carrier bed 9 and the supporting elements 10 respectively is preferably a polycarbonate.

In FIGS. 1 and 2, the fitting part 1 is illustrated in its finished or final form EF. During the production of the fitting part 1, however, before an injection of plastic material takes place behind the metal foil 7 for the carrier bed, a bent preform VF is imposed on the metal foil 7, as will now be explained in detail by reference to the sectional views of FIGS. 3 to 5.

The final form EF is illustrated by broken lines in FIGS. 3 to 5, whereas the preform VF deviating from the final form EF is illustrated by solid lines. As illustrated in the sectional view of FIG. 3, the preform VF has a bending or camber in a first direction; that is, the metal foil 7 is bent along the length 4 such that the lateral ends 23—starting from the final position EF—are deflected upwards. As illustrated in FIGS. 3 and 4, the bending can be differently pronounced along the length 5 or the width and, particularly in the direction of the outer bordering of the fitting part 1, may increased in the bending angle α.

In addition to the above-described directions for the bending into the preform VF, the metal foil 7, as seen in FIG. 5, can be bent in an additional direction at an angle, particularly obliquely, with respect to the two other directions along the length 4 and the width 5 respectively. On the whole, before the carrier bed 9 is injected behind it, the metal foil 7 may therefore, for example, be changed into a spherical-cap-shaped preform VF. For the injection behind the metal foil, a metal foil 7 is used which consists particularly of high-grade steel and has a thickness D (see FIG. 2) which measures less than 1 mm, preferably less than 0.5 mm, and particularly about 0.4 mm.

Thus, for producing the fitting part 1, the metal foil 7 is first changed into the preform VF and the hot plastic material for the carrier bed 9 is subsequently injected behind it. For this purpose, a tool 25 is preferably used which is illustrated in FIG. 6 in a very simplified and schematic manner. It has an upper and a lower tool half 26, 27 which, placed upon one another, bound a cavity 28 into the metal foil 7 is inserted. Subsequently the plastic material for the carrier 8′ is injected behind the space of the cavity 28 not filled by the metal foil 7. In this case, the cavity 28 with its boundary walls 29 is constructed such that a bent course is created which corresponds to the preform VF. After the finished fitting part 1 has been removed from the tool 25 and is cooling, it will automatically—starting from the preform VF—restore itself into the finished or final form EF. In particular, the preform VF is selected such that the final form EF is present without a bend in one of the directions (length 4, width 5 and/or transversely thereto).

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. Method for producing a motor vehicle fitting part, injecting a plastic material essentially over the full surface behind a metal foil and the fitting part has a finished or final form, after the metal foil has been changed to a bent perform state extending at least in a first direction which deviates from the finished or final form, such that the plastic material is applied to the thus deformed metal foil.

2. Method according to claim 1, wherein a respective bending angle of the bent preform is selected to be increasingly larger in a bordering direction of the metal foil.

3. Method according to claim 1, wherein the metal foil, in its preform state, is bent in a second direction.

4. Method according to claim 3, wherein a respective bending angle of the bent preform is selected to be increasingly larger in a bordering direction of the metal foil.

5. Method according to claim 1, wherein a polycarbonate is the injectable plastic material.

6. Method according to claim 1, wherein a high-grade steel foil is the metal foil.

7. Method according to claim 6, wherein a polycarbonate is the injectable plastic material.

8. Method according to claim 7, wherein a respective bending angle of the bent preform is selected to be increasingly larger in a bordering direction of the metal foil.

9. Method according to claim 1, wherein the metal foil has a thickness of less than 1 mm.

10. Method according to claim 1, wherein the metal foil has a thickness of less than 0.5 mm.

11. Method according to claim 1, wherein the metal foil has a thickness of less than 0.4 mm.

12. Method according to claim 1, wherein the metal foil has a length which is substantially greater than a width thereof.

13. Method according to claim 12, wherein a respective bending angle of the bent preform is selected to be increasingly larger in a bordering direction of the metal foil.

14. Method according to claim 13, wherein the metal foil, in its preform state, is bent in a second direction.

15. Method according to claim 14, wherein a polycarbonate is the injectable plastic material.

16. Method according to claim 15, wherein a high-grade steel foil is the metal foil.

17. Method according to claim 16, wherein the metal foil has a thickness of less than 1 mm.

18. Motor vehicle fitting part comprising a metal foil on which a plastic material has been injected in accordance with the method of claim 1.
